(19) United States
(12) Patent Application Publication
(10) Pub. No.: US 2002/0097395 A1
(43) Pub. Date: Jul. 25, 2002

(54) System and method for testing liquid crystal displays and similar devices

(76) Inventors: Peter Smith, Chandler, AZ (US); Dan Hoffman, Apache Junction, AZ (US); Matthias Pfeiffer, Mesa, AZ (US); Andrew R. Slater, Flower Mound, TX (US); Ellis Erwin, Mesa, AZ (US); Wyatt Lee Hendrick, Scottsdale, AZ (US)

Correspondence Address: MERCHANT & GOULD PC, P.O. BOX 2903, MINNEAPOLIS, MN, 55402-0903, US

(21) Appl. No.: 09/953,575

(22) Filed: Sep. 10, 2001

Related U.S. Application Data
(60) Provisional application No. 60/231,671, filed on Sep. 11, 2000.

(51) Int. Cl. G01N 21/00

(52) U.S. Cl. 356/239.2

(57) ABSTRACT

A LCD test system is provided for use in a high volume production environment. An automated test is performed that tests each LCD and provides a pass/fail indication. The automated test includes an image-sticking test that drives the test image based on a control voltage that corresponds to a maximum rate of change of brightness. The control voltage is determined by differentiating an electro-optic curve. The brightness difference between the test image and another test image is compared to predetermined threshold. The other test image may be a gray scale test. Alternatively, the image-sticking test may integrate brightness levels of odd and even frames, compare these results to predetermined thresholds. The test includes a color uniformity test in which average differences in peak reflectance and peak frequency within sections of the LCD are compared to predetermined thresholds for the pass/fall indication. The test includes a spatial distribution of defects test.

### RELATED APPLICATIONS

This utility patent application claims the benefit under 35 United States Code § 119(e) of U.S. Provisional Patent Application No. 60/231,671 filed Sep. 11, 2000.

### FIELD OF THE INVENTION

The present invention relates to liquid crystal displays and similar electro-optical devices. More specifically, the present invention relates to testing of liquid crystal displays and similar devices.

### BACKGROUND INFORMATION

Liquid crystal displays (LCDs) and, in particular, liquid crystal on silicon (LCoS™) displays are being produced in relatively large volumes to meet an increasing demand. Typical conventional LCD test equipment provides only measurements for characterizing the display. The measurements are based on vendor-selected parameters, such as system contrast, spectrum, blemishes, brightness, contrast ratio, gray-scale uniformity and others. An operator then analyzes the measurements and determines whether the LCD is suitable for sale to customers. This type of conventional test system tends to be a bottleneck in the testing process and is, thus, not a desirable test system for use in a high volume production environment. In addition, this type of conventional test equipment does not test a number of parameters that are useful in determining whether an LCD device is suitable for sale.

Therefore, there is a need for a test system that is suitable for use in a high volume LCD production environment and that is more accurate in determining the suitability of LCDs for sale to customers.

### SUMMARY

In accordance with aspects of the present invention, a LCD test system is provided for use in a high volume production environment. In one aspect of the present invention, an automated test is performed that tests each LCD and provides a pass/fail indication. This system advantageously speeds the testing process relative to the aforementioned conventional LCD test systems.

In another aspect of the present invention, an image-sticking test is performed. Image sticking, as used herein, occurs when an image displayed by the LCD persists after the image is changed. In this aspect of the present invention, the inventors have appreciated that the degree or severity of image sticking can be related to the rate of change of brightness as a function of LCD control voltage. That is, the higher the rate of change of brightness at a given control LCD voltage, the greater the risk of image sticking because a small voltage change at such a point should result in a greater brightness change. Thus, the maximum degree of image sticking is most likely to occur at the LCD control voltage that produces the maximum rate of change of brightness. In this aspect, a brightness vs. control voltage curve for the LCD under test is generated. The second derivative of the curve is then calculated to determine the voltage at which the maximum rate of change of brightness occurs. This voltage is then used in driving a test image (having a purely black portion and a purely white portion) on the LCD for a period of time. The image is then switched to a known image and the brightness measured. The brightness corresponding to a region that was previously purely black is compared to the brightness corresponding to a region that was previously white. The brightness difference corresponds to image sticking. The brightness difference is then compared to a predetermined threshold that corresponds to the maximum acceptable level of image sticking as part of a pass/fail test.

In another aspect of the present invention, image sticking is tested by causing the LCD to display a first test image for a predetermined period of time. The first test image has an all black region and an all white region. The brightness of the first test image is measured as a function of location on the LCD. Then a second test image is displayed when the first predetermined time period expires. The second test image is a gray scale. The gray scale is produced by varying the LCD control voltage so that the voltage level is known as a function of location on the LCD. The brightness of the second test image is measured as a f unction of location. Then the difference in brightness (for a formerly white area compared to a formerly black area) as a function of voltage is calculated The difference calculation for the entire voltage range is then compared to a predetermined threshold value that corresponds to the maximum acceptable level of image sticking in a pass/fail test. By using a gray scale, this embodiment avoids the relatively intensive calculations required to determine the voltage of the maximum rate of brightness change.

In yet another aspect of the present invention, image sticking is tested by separately measuring the brightness of odd frames and even frames. This test requires synchronization between the brightness measuring device and the LCD so that odd frames may be measured separately from even frame. During odd frames, while displaying a test image that has portions of different gray levels (e.g., a purely black portion and purely white portion). The brightness levels of the odd and even frames are respectively summed or integrated. If the centerlines for all gray levels were equal, the sum of the odd frames would be the same as the sum of the even frames. However, if the centerlines were not equal, the sums would be different. The difference between the odd frame sum and the even frame sum is then compared to a predetermined threshold value that corresponds to the maximum acceptable level of image sticking in a pass/fail test.

In still another aspect of the present invention, the uniformity of color of the LCD is tested In one embodiment, the LCD is illuminated with light of having a predetermined frequency band, and the reflectance is measured. For various points on the LCD, the peak reflectance (and the corresponding frequency) is determined The peak reflectances and frequencies are then compared. For example, in one embodiment, the average difference in peak reflectance and peak frequency are calculated and compared to a predetermined threshold in a pass/fail test.

Another aspect of the invention tests the performance of an LCD under various temperatures. In this aspect, the inventors have appreciated that various defects become more pronounced under different temperatures. This observation is used to more easily detect defects. For example, screen knuckles in the LCD and small particulate contamination of the liquid crystal are more easily detected at relatively high temperatures. In one embodiment, the LCD is placed in a heating chamber and heated to a temperature above normal room temperature to about 50° C. Then the LCD is optically examined for screen knuckling and particulates.

Yet another aspect of the invention measures the spatial distribution of defects (e.g., stuck pixels). In one particular aspect, the distance between defects is measured (nearest neighboring defects). A pass/fail test is implemented based on the number of defects within predetermined nearest neighbor distances. For example, in many applications, widely separated defects are more tolerable than closely spaced defects. In a further refinement, in projection type LCDs, the nearest neighbor distance can be scaled to account for the actual distance between defects in the projected image.

### BRIEF DESCRIPTION OF THE DRAWINGS

FIG. 1 illustrates diagrams for explanation of an image-sticking test according to one embodiment of the present invention;

FIG. 2 illustrates diagrams for explanation of another image-sticking test according to another embodiment of the present invention;

FIG. 3 illustrates diagrams for explanation of yet another image-sticking test according to yet another embodiment of the present invention;

FIG. 4 illustrates diagrams for explanation of a color uniformity test according to one embodiment of the present invention;

FIG. 5 illustrates diagrams for explanation of a spatial defect distribution test according to one embodiment of the present invention;

FIG. 6 illustrates one embodiment of the zones for use in the spatial defect distribution test shown in FIG. 5;

FIG. 7 illustrates another embodiment of the zones for use in the spatial defect distribution test shown in FIG. 5;

FIG. 8 illustrates a temperature test according to one embodiment of the present invention; and

FIGS. 9 and 10 illustrate a tray for holding LCDs and a handler for use with the tray.

### DETAILED DESCRIPTION

In a high volume LCD production environment, the inventors of the present invention have appreciated that it is desirable that tests and test equipment provide pass/fail indications, in addition to measurements of performance. As used herein, LCD includes LCoS™ devices available from Three-Five Systems, Inc., Tempe, Ariz. In addition, LCD includes other optical devices, such as optical switches, complementary metal oxide semiconductor (CMOS) imagers, charge-coupled device (CCD) imagers and the like. Typical conventional LCD test equipment uses cameras having a relatively high resolution compared to the resolution of the LCD to measure parameters of a test image displayed by the LCD under test. However, the test equipment currently available from vendors provides what is referred to herein as characterization data. That is, the data provided are measurements of certain vendor-selected parameters, without any mechanism, means or intelligence to determine whether the measured parameter is within a specified tolerance. This determination is made by an operator. Thus, such test equipment cannot be easily automated. The costs involved in such a test system are relatively high and generally result in a throughput bottleneck in a high volume production environment.

In accordance with the present invention, a tester is configured to be programmable with user-defined tolerances for various parameters measured by the tester. In addition, the tester is configured to compare the measured parameters to the user-defined tolerances in an automated test process to provide a pass/fail indication for the LCD. In a further refinement, the tester is configured to provide additional processing of some measurements (e.g., brightness vs. LCD control voltage measurements) to provide a parameter (e.g., the derivative of the brightness vs. LCD control voltage curve) that can be easily compared to a predetermined tolerance for that parameter. One embodiment includes the following steps. The tester is loaded with a LCD to be tested. This step can be performed man fully by an operator, or by a robot. In one embodiment, the tester, under the control of a suitably programmed controller or processor (i.e., computer control), provides power and control to the LCD to display an image that is then measured. In particular, the tester measures a predetermined performance parameter of the LCD and compares the measurement to an expected result. This expected result might be in the form of a range of acceptable values or a threshold value that indicates a maximum or minimum acceptable value. Depending on the measurement, the tester then indicates whether the LCD passed or failed the test. If the LCD passed the test, the LCD can then proceed to a next step in the production process, which may include further tests. In view of the present disclosure, one skilled in the art of LCD testers can provide such automated test functionality without undue experimentation.

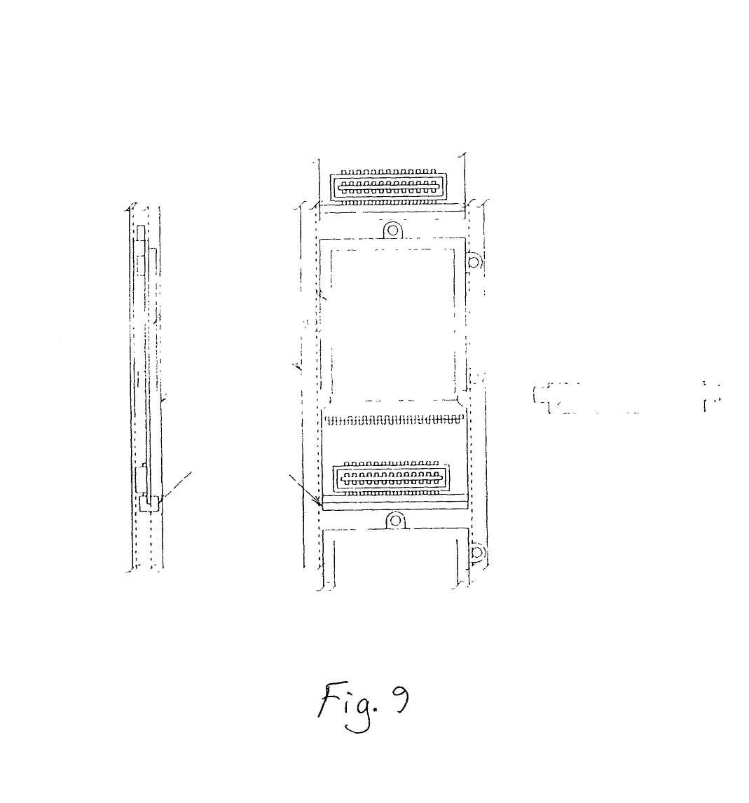

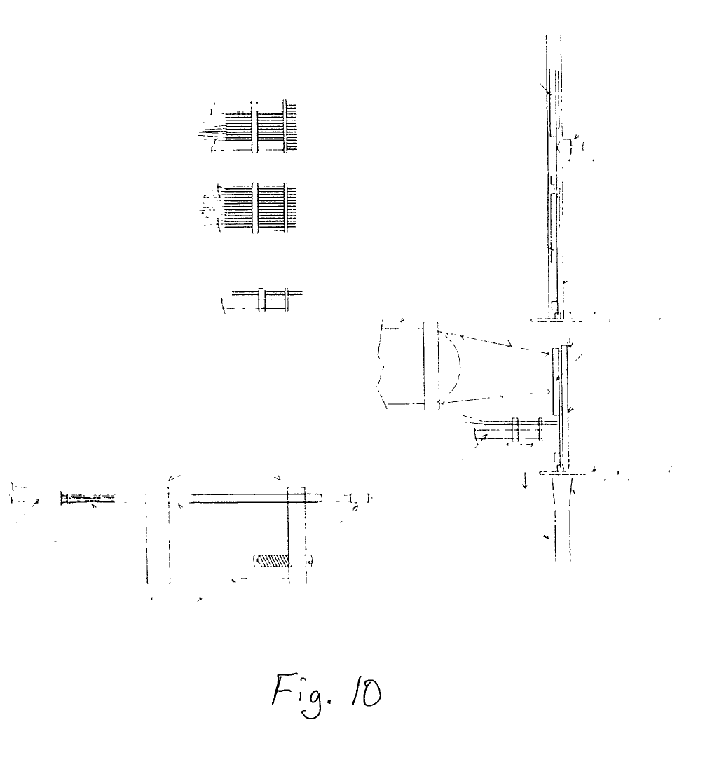

The aforementioned conventional testers typically require manual insertion of an LCD into the tester. This also tends to make the automation of the testing process impractical. To facilitate automated testing and to provide protection for LCD parts while being transported and loaded into the tester, a tray or rail according to the present invention is used In one embodiment, the tray is designed to hold several LCD devices. The tester, according to the present invention is correspondingly adapted to accept and handle the trays. By handling the trays instead of the LCDs directly, the test process can be automated and can reduce the risk of damaging the LCDs. FIGS. 8 and 9, discussed below, illustrate one embodiment of a tray and a correspondingly adapted handling mechanism for the tester.

In addition, such test equipment typically has only a limited number of vendor-selected parameters. For example, typical vendor-selected parameters include system contrast, spectrum, blemishes, brightness, contrast ratio, gray-scale uniformity and some others. However, the inventors of the present invention have found other parameters that provide a good indication of the functionality of the LCD under test. For example, when the image displayed by a LCD is changed, the previous image may persist for a period of time on the LCD, thereby reducing the quality of the new image that is to be displayed This parameter is referred to herein as image sticking and is believed to be a property of the device.

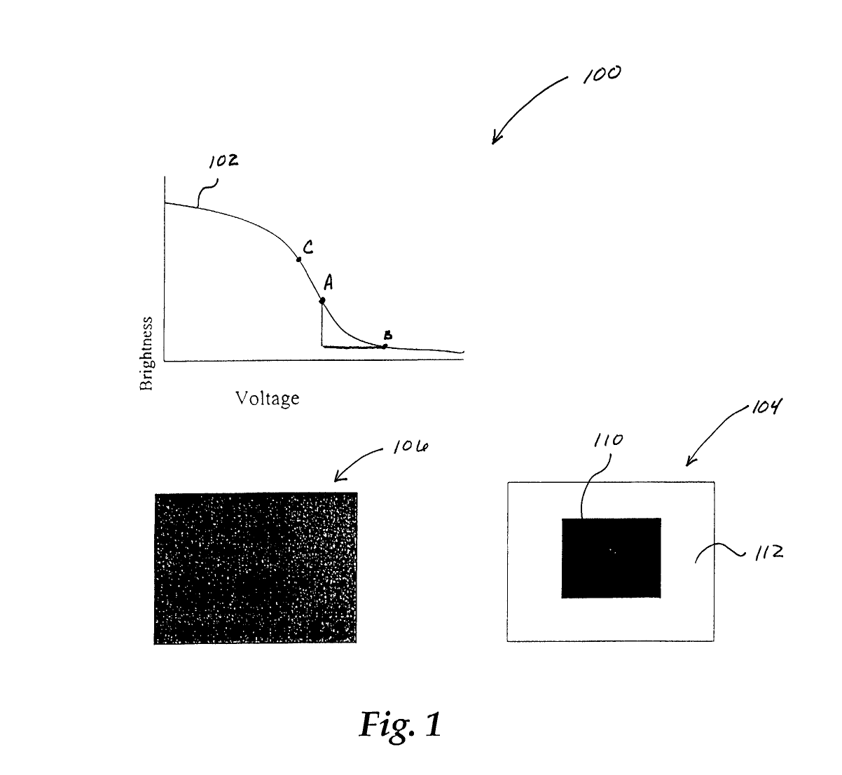

FIG. 1 illustrates diagrams for explanation of an image-sticking test 100 according to one embodiment of the present invention. In this embodiment of the present invention, the inventors have appreciated that the degree of image sticking is related to the rate of change of brightness as a function of LCD control voltage. One of the diagrams is a graph 102 illustrating an electro-optic curve of the relationship between the LCD control voltage (shown on the x-axis) and the brightness (shown on the y-axis). The LCD control voltage ranges from 0 volts to a pre-determined voltage (i.e., a maximum supply voltage). The brightness n ay be described as ranging from black (i.e., lowest point of electro-optic curve) to white (i.e., highest point of electro-optic curve). By differentiating the electro-optic curve, the voltage associated with the maximum rate of change may be determined The inventors have observed that the maximum degree of image sticking occurs at the LCD control voltage that produces the maximum rate of change of brightness. On the graph 102, this maximum rate of change of brightness is generally represented by the electro-optic curve between point A and point B. That is, an observer looking at the LCD display is most sensitive to image sticking at the point at which the maximum rate of change of brightness occurs.

In one embodiment, this observation is used to determine a pass/fail type test for image sticking. The tester is configured to make measurements in an electro-optic test. For example, as illustrated in graph 102 above, the tester can be configured to measure brightness vs. LCD control voltage. Although this embodiment uses brightness and voltage, those skilled in the art, in light of this disclosure, can implement other embodiments that use other parameters. For example, instead of brightness, the tester can measure reflectance after illuminating the LCD with a light, or throughput after illuminating the LCD with a light.

In one particular embodiment, after the electro-optic curve is generated, the tester determines a voltage at which the maximum rate of change occurs in the brightness. For example, the tester can calculate the second derivative of the brightness vs. voltage curve to find the maximum rate of change. The voltages corresponding to the maximum rate of change (i.e., voltages between point A and point B) are then used to drive an all black region 110 of a black and white test image 104 for a predetermined amount of time. These voltages are used because, as mentioned earlier, the inventors have observed that the maximum degree of image sticking occurs at the LCD control voltage that produces the maximum rate of change of brightness.

In the embodiment shown in FIG. 1, the black and white test image 104 has an all black region 110 and an all white region 112. The all black region 110 consumes an inner area of the black and white test image 104and the all white region 112 consumes an outer area of the black and white test image 104. However, in an alternative embodiment, the black and white test image 104 may have the all black region 110 as the outer area and the all white region 112 as the inner area or have any other configuration for the all black/white areas without departing from the scope of the present invention. For any of the embodiments, the tester measures the brightness of the black and white test image 104. The longer the predetermined amount of time that the voltages drive the all black region, the more severe the image sticking test and the more likely image sticking will occur.

After the predetermined amount of time, the tester causes the LCD to display a gray level test image 106 (e.g., 50% gray). One gray level test image corresponds to a LCD control voltage approximately midway between the LCD control voltage for the white and black brightness (e.g., point C). The tester then measures brightness associated with this gray level test image 106. The brightness of the formerly all black region 110 is compared to the brightness of the formerly all white region 112, which serves as a baseline. If any portion of the formerly all black region 110 has a brightness that is different than the brightness of the formerly all white region 112 when the gray level test image 106 is displayed on the LCD, that portion of the formerly all black region is determined to have image sticking. The difference in brightness between the areas is related to the degree of image sticking, which is then compared to a predetermined threshold value for a pass/fail test. This threshold is determined to correspond to the maximum tolerable level of image sticking, which can be found empirically. For example, an illustrative threshold may correspond to a 5% change in brightness.

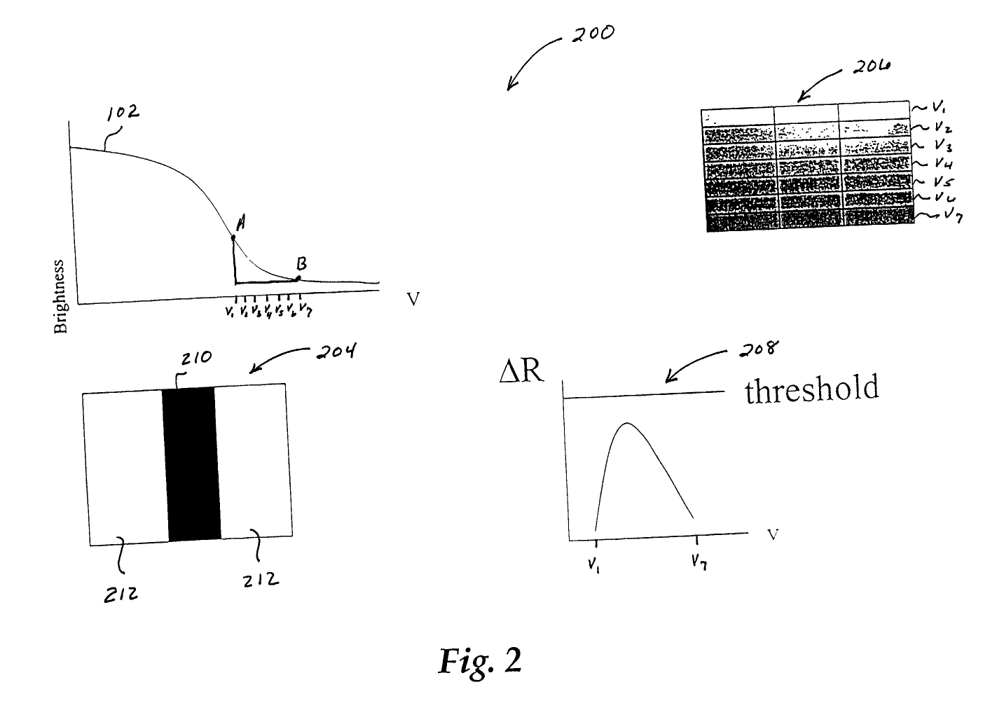

FIG. 2 illustrates diagrams for explanation of another image-sticking test 200 according to another embodiment of the present invention. The diagrams are similar to the diagrams used for explaining the image-sticking test 100 illustrated in FIG. 1. However, image sticking test 200 in this embodiment, uses a gray scale test image 206 rather than a single gray level test image 106 as illustrated in FIG. 1. In this embodiment, rather than generating an electro-optic curve 102 as was done in FIG. 1, predetermined voltages V₁-V₇ that correspond to the maximum rate of change (i.e., voltages between point A and point B) are used to generate the gray scale test image 206. In the illustrated gray scale test image 206, there are seven gray scales. However, there may be any number of gray scales without departing from the scope of the present invention.

For this embodiment, the tester causes the LCD to display a first test image 204 for a predetermined period of time. A longer predetermined period of time corresponds to a more severe image-sticking test. Again, the first test image 204 has an all black region 210 and an all white region 212. The brightness of the first test image 204 is measured as a function of location on the LCD. When the first predetermined time period expires, a second test image (e.g., the gray scale test image 206) is displayed The gray scale test image 206 has predetermined gray levels that are produced by varying the LCD control voltage. Thus, the gray scale test image 206 has voltage levels that are known as a function of location on the LCD. The brightness of the second test image 206 is measured as a f unction of location. The brightness of the formerly all white region 212 is compared with the brightness of the formerly all black region 210 with respect to the second test image 206. The difference (ΔR) in the brightness is calculated as a function of voltage or function of gray level (see graph 208). If a difference (ΔR) occurs, this denotes some degree of image sticking. The difference (ΔR) will be dependent on the gray level used to calculate the difference. For example, the gray level V₇ may have a smaller difference calculation than the gray level V₁ but may still have the same degree of image sticking. Thus, the difference calculation is compared to a threshold that varies as a function of LCD control voltage. In another embodiment, the threshold is set at a predetermined value and does not vary. The threshold is used in determining the result of a pass/fail test.

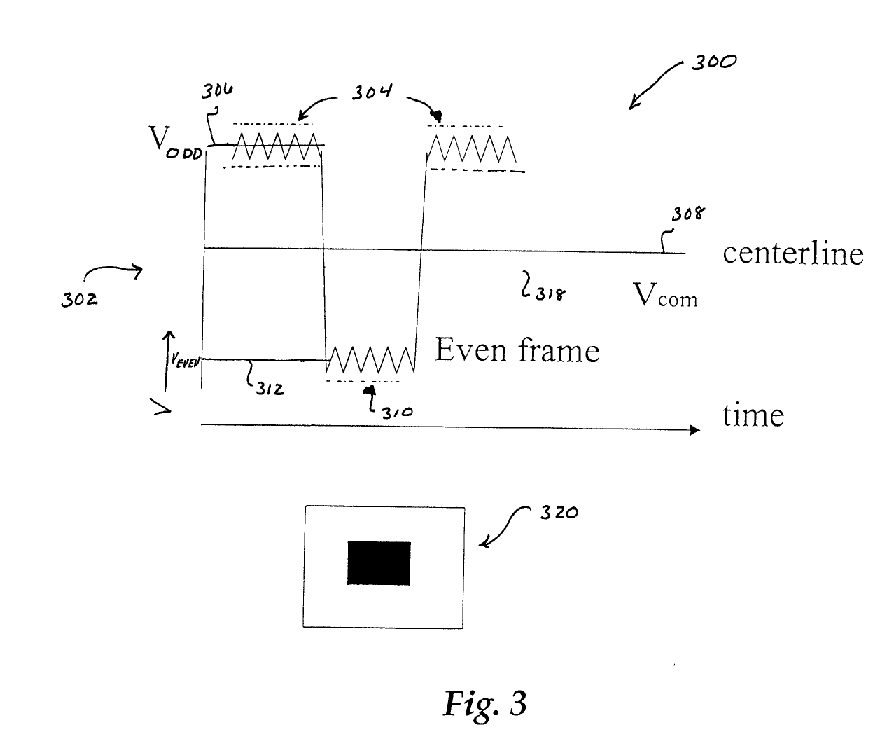

FIG. 3 illustrates diagrams for explanation of another image-sticking test 300 according to another embodiment of the present invention. The image-sticking test 300 may also be referred to as a flicker test. Images are typically displayed in even and odd frames. Referring to the voltage versus time diagram 302, the odd frames 304 use a DC bias level 306 (also referred to as V_{ODD}) that is offset above a centerline voltage 308 by a predetermined amount and the even frames 310 use a DC bias level 312 (also referred to as V_{EVEN}) that is offset below the centerline voltage 308 by the same predetermined amount. Unfortunately, due to mismatches or other imperfections in the LCD device, the resulting voltage offset (i.e., the bias voltage plus the LCD control voltage) in displaying a gray level in odd frames 304 may be different from the resulting voltage offset of this same gray level in even frames 310. In a normally white display, typically, this effect is most pronounced with a purely black image. This effect may be viewed as this gray level having an actual centerline voltage 318 (also referred to as V_{COM}) that is not the ideal centerline 308. This aspect of the present invention uses the different “effective” centerlines of different gray levels to test for flickering. If the difference in centerlines between one gray level and another gray level is relatively large, an observer would perceive a flickering image.

In one embodiment of image-sticking test 300, a tester causes the LCD to display a test image 320 having a black region 322 in the middle of white region 324 that is the background (see FIG. 3). In other embodiments, other test images may be used as long as there are at least two different gray levels in the test image. As previously described, odd frames 304 have a predetermined DC bias voltage offset 306 above the ideal centerline 308. Even frames 310 ideally have the same value of DC offset but below the ideal centerline 308.

This image sticking test 300 requires synchronization between the LCD and the brightness-measuring device (e.g., a camera) of the tester. In one embodiment, the tester's camera is configured to use a fast shutter period The tester integrates the measured brightness of odd frames 304 and integrates the measured brightness of even frames 310. This increases the signal to noise ratio. The tester then determines the difference between the integrated brightness of the odd frames 304 and the integrated brightness of the even frames 310. If there is no appreciable difference, the LCD passes this image sticking test 300. If there is an appreciable difference, the difference is then compared to a predetermined tolerance. If the difference exceeds the predetermined tolerance, then flicker is too great and the LCD fails the test. The predetermined tolerance may range from 0.5-6%. For image sticking test 300, the test area may be as small as a pixel.

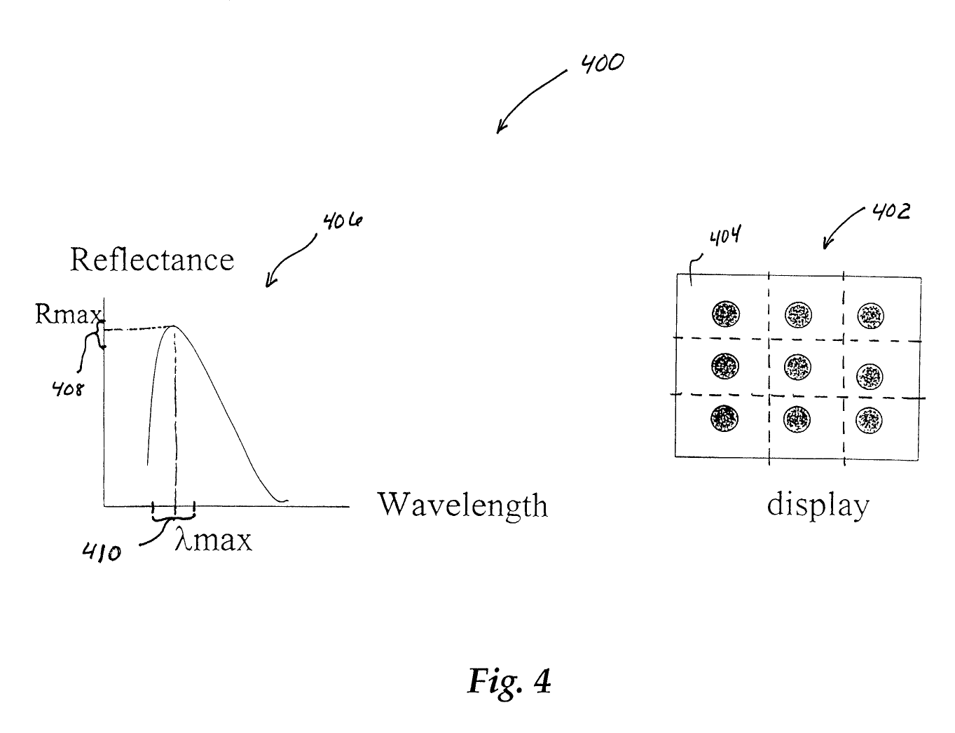

FIG. 4 illustrates diagrams for explanation of a color uniformity test 400 according to another embodiment of the present invention. For this embodiment, the inventors have appreciated that LCDs may have variations in color coordinates and may have variations in cell gap across the LCD. The color uniformity test 400, in accordance with the present invention, is directed at providing a pass/fail test for these variations. One of the diagrams shown for the color uniformity test 400 is an illustrative LCD 402 divided into several sections 404. In the embodiment shown, the LCD 402 is divided into nine sections 404. However, the LCD 402 may be divided into any number of sections without departing from the scope of the present invention. For each section 404, a reflectance versus wavelength graph 406 is generated

For each of the reflectance versus wavelength graph 406, the LCD is illuminated with light having a predetermined wavelength (e.g, white light), and the reflectance is measured The reflectance will vary based on the optical properties of the glass, the cell gap and the optical properties of the silicon. The peak reflectance R_{MAX} and the corresponding wavelength W_{MAX} are then determined for each section 404. The peak reflectance R_{MAX} and wavelengths W_{MAX} of each section 404 are then compared. For example, in one embodiment, the reflectance versus wavelength graph 406 may indicate a first range 408 that corresponds to an acceptable range of reflectance values in which the peak reflectance R_{MAX} of each section 404 should fall in order for the LCD to pass. Likewise, the graph 406 may indicate a second range 410 that corresponds to an acceptable range of wavelengths in which the peak wavelength W_{MAX} should fall in order for the LCD to pass. In another embodiment, the average difference in peak reflectance and peak wavelength are calculated and compared to a predetermined threshold in a pass/fail test. In other embodiments, the differences may be based on a mean, a median, a mode and the like. If there are no appreciable differences, the LCD may be considered to have a uniform display. When there are appreciable differences between the sections 404 of the LCD 402, the LCD will fail and will be handled accordingly.

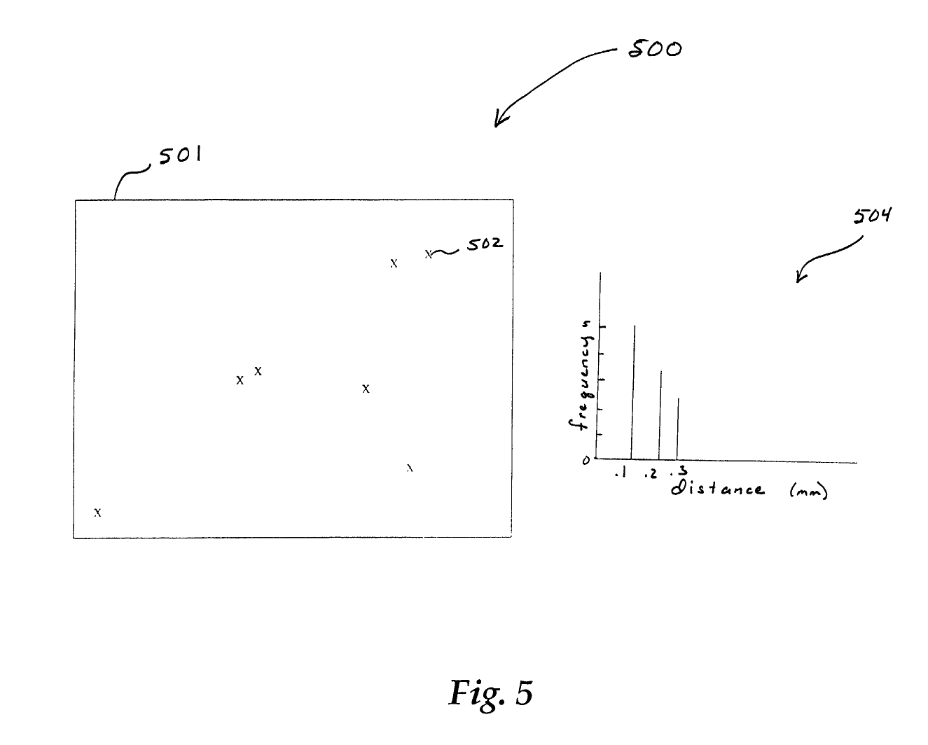

FIG. 5 illustrates diagrams for explanation of a spatial distribution test 500 in accordance with yet another embodiment of the present invention. For this embodiment, the tester measures the spatial distribution of pixel defects. For example, the defect may be a bright pixel in a dark field or a dark pixel in a bright field, or a pixel having a different shade of gray compared to neighboring pixels that are supposed to display the same gray shade. In one particular aspect of this embodiment, the distance between defects is measured (i.e., referred to herein as nearest neighboring defects). In FIG. 5, a graphical plot 501 illustrates the location of defects 502 within a zone 504 (not shown) of an LCD.

Based on the defects 502, a frequency versus distance graph 504 is generated The scale for the distance (x-axis) is based on the distance between pixels and will vary based on the LCD under test. For example, the distance between pixels for an illustrative LCD is shown as 0.1 millimeters (mm). The frequency (y-axis) represents the number of defects 502 having another defect 502 (i.e., a neighboring defect) within the corresponding distance. For example, the frequency versus distance graph 504 indicates that there are five defects having another defect within 1 mm, three defects having another defect within 2 mm, and two defects having another defect within 3 mm. A pass/fail test may then be implemented based on the number of defects within predetermined nearest neighbor distances. For example, widely separated defects 502 are more tolerable than closely spaced defects 502. In a further refinement, in projection type LCDs, the nearest neighbor distance (x-axis) can be scaled to account for the actual distance between defects in the projected image. In another embodiment, criteria may be set-up to grade the LCD based on the frequency versus distance graph 504. The LCDs may then be binned and priced accordingly.

For these embodiments, the pass/fail test and criteria maybe based on a minimum distance between defects (also referred to as a minimum defect region). This minimum distance may be as small as zero or as large as the zone. The pass/fail test and criterion may further be based on a maximum number of defects in the minimum defect region. In other words, if the minimum distance between defects is set to 0.1 mm, the maximum number of defects having a neighboring defect within the 0.1 mm may range from 1 upwards. The lower the maximum number of defects allowed, the greater the quality of the LCD. The pass/fail test and criteria may further include a maximum number of minimum distance defect regions. This criterion counts the instances that fail all the previous criteria.

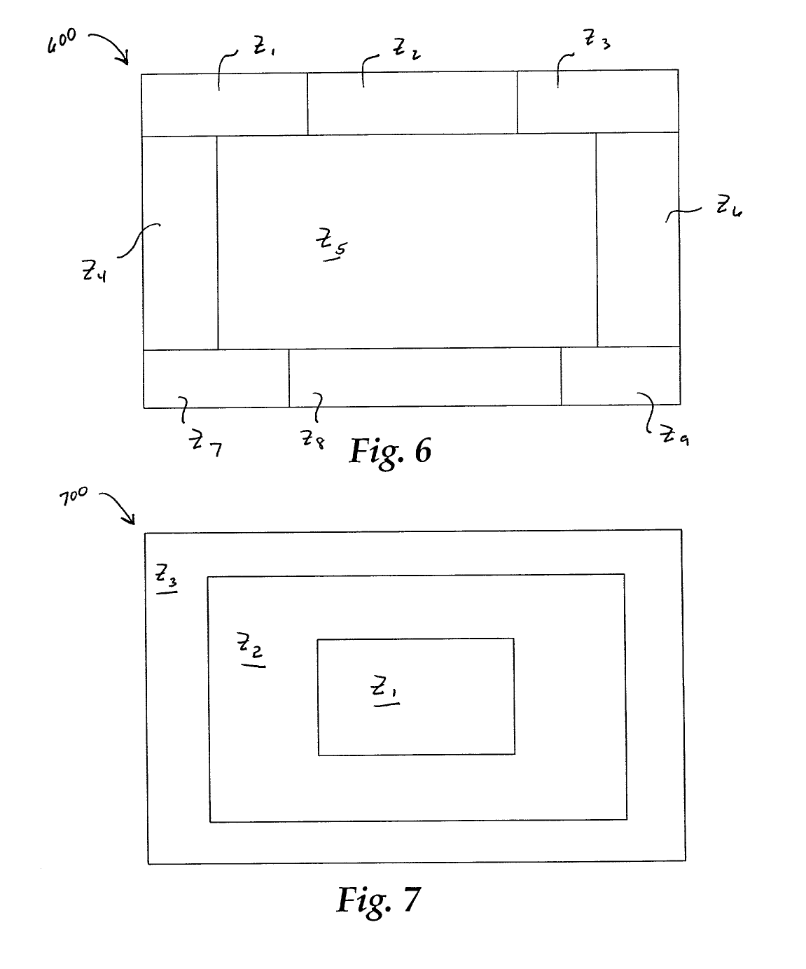

FIG. 6 illustrates one embodiment of the zones for use in the spatial distribution test 500 shown in FIG. 5. For this embodiment, the LCD 600 is divided into several zones Z₁₉ that do not overlap (i.e., a flat hierarchical zone). Each zone Z may have different criteria or may have the same criteria. For example, zone Z₅, which is in the center of the LCD, may have more stringent criteria than any of the outer zones Z.

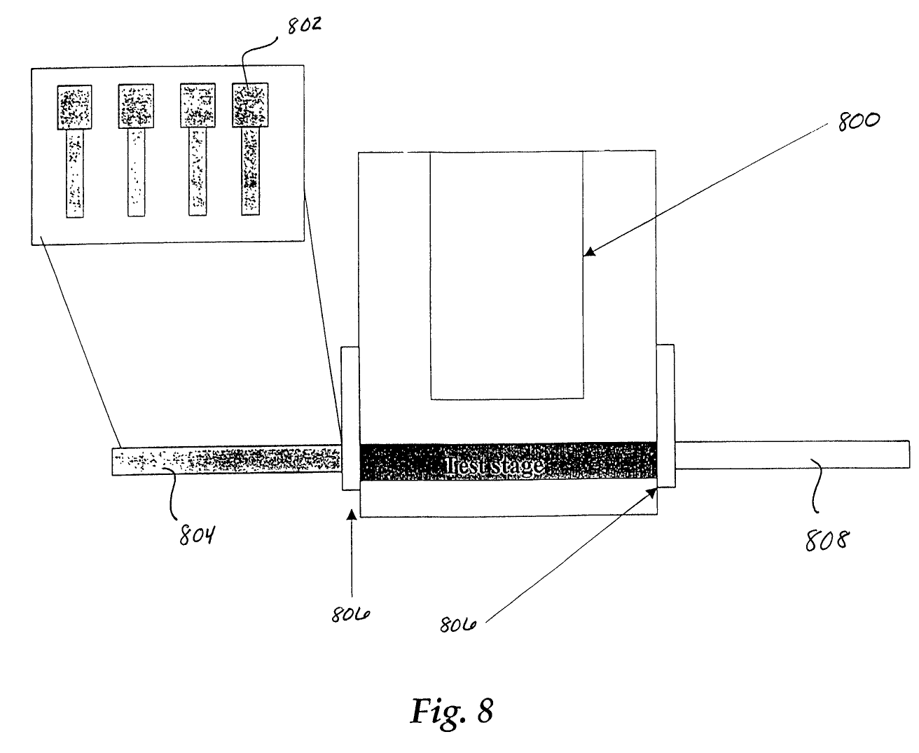

FIG. 7 illustrates another embodiment of the zones for use in the spatial distribution test 500 shown in FIG. 5. For this embodiment, the LCD 700 is divided into overlapping zones or ring-like zones. Again, each zone may have different criteria or may have the same criteria. For example, zone Z1, which is in the center of the LCD, may have criteria that disallows any bright or dark pixel defect above a certain threshold. The next outer zone, zone Z2, may allow only N number of dark defects, but no bright defects. The next outer zone, zone Z3, may allow N number of dark defects and N number of bright defects. As one can se, the requirements become more lenient as the zones become further from the center.

While FIGS. 6 and 7 illustrate some embodiments for the zones, other zone configurations may also be used without departing from the scope of the present invention. For example, each zone may be a vertical bar that has criteria based on the position of the bar in relation to the center of the LCD. These and other variations will be appreciated by those skilled in the art in conjunction with the teachings of the present invention.

FIG. 8 illustrates another aspect of the present invention that tests the performance of an LCD under various temperatures. For this aspect, the inventors have appreciated that various defects become more pronounced under different temperatures. For example, screen knuckles in the LCD and small particulate contamination of the liquid crystal are more easily detected at relatively high temperatures. Based on this observation, temperature testing is performed to detect these defects more easily. In one embodiment, a controlled chamber 800 is used for testing the LCD. The LCD 802 is placed on a parts tray 804 that is moved into the controlled heating chamber 800. Two interlocks 806 close the heating chamber 800. The LCD 802 in the heating chamber 800 is heated to a temperature above normal room temperature. In one embodiment, the temperature reaches about 50 20 C. Then the LCD is optically examined for screen knuckling and particulates. The heating within the heating chamber 800 may be performed using an electro-thermic heating (e.g., peltier stage heating), forced air conduction through the base-plate, illumination, and the like.

FIG. 9 illustrates a tray or rail used to handle LCDs during the testing process. FIG. 10 illustrates a handler for use in a tester for handling trays or rails of LCDs. A tray is attached to the handler in a vertical position. The handler has a gate that is opened to allow a LCD to drop into the tester in the proper position for a camera to view the display portion of the LCD and expose electrical contact points for power and control to a contactor assembly. The handler's contactor assembly has spring-loaded conductive contacts that the handler can bring into physical contact with the LCD's electrical contact points to allow the handler to provide power and control signals to the LCD in accordance with the tests.

The above specification, examples and data provide a complete description of the manufacture and use of the composition of the invention. Since many embodiments of the invention can be made without departing from the spirit and scope of the invention, the invention resides in the claims hereinafter appended.

We claim:

1. A method for testing optical devices, the method comprising:
(a) performing at least one automated test on the optical device; and
(b) providing an indication on whether the optical device passed the at least one automated test.

2. The method of claim 1, wherein the at least one automated test includes an image-sticking test.

3. The method of claim 2, wherein the image-sticking test includes
(a) determining a control voltage that produces a maximum rate of change of brightness;
(b) displaying a first test image on the optical device, the first test image comprising a first region and a second region with each region having a different level, the first region being driven by the control voltage for a predetermined period of time;
(c) measuring a first parameter associated with the first test image;
(d) displaying a second test image on the optical device;
(e) measuring a second parameter associated with the second test image;
(f) determining a difference by comparing the first and second parameters in relation to the first and second regions; and
(g) upon determining the difference is appreciable, setting the indication as a failure.

4. The method of claim 3, wherein the first parameter includes one of a brightness, a reflectance and throughput.

5. The method of claim 3, wherein the first region is black and the second region is white.

6. The method of claim 3, wherein the second test image includes a gray level image.

7. The method of claim 2, wherein the image-sticking test includes
(a) displaying a first test image on the optical device, the first test image comprising a first region and second region with each region having a different brightness;
(b) measuring a first parameter associated with the first test image based on location on the optical device;
(c) displaying a second test image having predetermined gray levels;
(d) determining a difference by comparing the second parameter that corresponds to the location of the first region with the second parameter that corresponds to the location of the second region; and
(e) if there is a difference comparing the difference with a predetermined threshold in determining whether to set the indication as a failure.

8. The method of claim 2, wherein the image-sticking test includes
(a) displaying a first test image on the optical device, the first test image comprising a first region and a second region with each region having a different gray level;
(b) measuring a first brightness for at least one odd frame and a second brightness for at least one even frame;
(c) integrating the first brightness for the at least one odd frame and integrating the second brightness for the at least one even frame;
(d) determining a difference between the integrated first brightness and the integrated second brightness;
(e) upon determining an appreciable difference, comparing the difference with a predetermined tolerance to determine whether to set the indication as a failure.

9. The method of claim 1, wherein at least one automated test includes a color uniformity test.

10. The method of claim 9, wherein the color uniformity test comprises
(a) determining a reflectance versus wavelength graph for each of a plurality of sections of the optical device;
(b) determining a peak reflectance and a corresponding peak wavelength for each of the plurality of sections;
(c) determining a difference by comparing the peak reflectance and the corresponding peak wavelength of each section; and
(d) upon determining that the difference is an appreciable difference, setting the indication as a failure.

11. The method of claim 10, wherein the difference is based on one of a mean, a median and a mode.

12. The method of claim 10, wherein determining that the difference is an appreciable difference includes comparing an average difference in peak reflectance and peak wavelength to a predetermined threshold.

13. The method of claim 1, wherein the at least one automated test includes a spatial distribution test for determining a frequency of defects within a plurality of distances.

14. The method of claim 13, wherein the indication is based on the frequency of defects within predetermined distances.

15. The method of claim 14, wherein the predetermined distances is scaled to account for an actual distance between defects for a projected image.

16. The method of claim 10, further comprising grading the optical device based on the frequency of defects within a plurality of distances.

17. The method of claim 10, further comprising dividing the optical device into a plurality of zones in which each zone has different criteria for determining the indication.

18. The method of claim 17, wherein the plurality of zones includes one of an overlapping configuration and a flat configuration.

19. The method of claim 1, wherein at least one automated test is performed at a temperature above ambient.

20. The method of claim 1, wherein the optical device includes a liquid crystal on silicon display.

21. The method of claim 1, wherein at least one automated test is performed at a temperature different from the temperature that results from the combination of ambient temperature and the incident radiation.
